(19) United States
(12) Patent Application Publication
(10) Pub. No.: US 2024/0141161 A1
(43) Pub. Date: May 2, 2024

(54) BIODEGRADABLE RESIN AQUEOUS DISPERSION, FILM FORMING AGENT USING SAME, AND METHOD FOR FORMING FILM

(71) Applicant: MIYOSHI OIL & FAT CO.,LTD., Tokyo (JP)

(72) Inventors: Shohei ITO, Iwakura-shi (JP); Masahiro OKUYA, Iwakura-shi (JP)

(73) Assignee: MIYOSHI OIL & FAT CO.,LTD., Tokyo (JP)

(21) Appl. No.: 17/979,401

(22) Filed: Nov. 2, 2022

(51) Int. Cl. C08L 67/04; C08J 5/18; C08L 29/04; C08L 33/02; C08L 33/26; C08L 71/02

(52) U.S. Cl. CPC C08L 67/04; C08J 5/18; C08L 29/04; C08L 33/02; C08L 33/26; C08L 71/02; C08J 2367/04; C08L 2201/06; C08L 2201/10; C08L 2201/50; C08L 2203/16

(57) ABSTRACT

Provided are a biodegradable resin aqueous dispersion from which a transparent film with an excellent biodegradability can be obtained without impairing the properties inherent to resins, and without performing a special heating treatment; a film forming agent using such dispersion; and a method for forming a film. The biodegradable resin aqueous dispersion of the present invention is an aqueous dispersion with a biodegradable resin being dispersed in an aqueous solvent under the presence of a non-ionic dispersant, comprising, as the biodegradable resin, a polycaprolactone having a weight-average molecular weight of 20,000 to 90,000, wherein a mass ratio of the non-ionic dispersant to the biodegradable resin is 0.03 to 0.23.

### BACKGROUND OF THE INVENTION

### Field of the Invention

The present invention relates to a biodegradable resin aqueous dispersion; a film forming agent using the same; and a method for forming a film.

### Background Art

In various fields and for various use applications such as coating material bases, covering agents and adhesive agents, there is used an aqueous resin dispersion with a polymer(s) being dispersed in water. Particularly, olefin-based resins, acrylic resins, urethane-based resins or the like are utilized in various fields and for various use applications as having an excellent functionally and convenience in a way such that structural designing is possible in view of performances required for a film, and that depending on the types of these resins, a uniform film can be formed without having to carry out a special heating treatment.

However, these polymers are not biodegradable, and will thus be semipermanently present in the environment after use, which has resulted in concerns over burdens on the environment. In this regard, various attempts to substitute these polymers with biodegradable ones are under consideration.

Not only in the case of a biodegradable resin, but in order for an aqueous resin dispersion to exert its functions after coating, it is required that the polymer in the form of fine particles dispersed in water become fusion-bonded to one another to form a unform film after the water has evaporated. The resins will be present in a white-colored state on the coated surface if they fail to be fusion-bonded to one another even after the water has evaporated. A uniform film may for example be formed by performing a heating treatment allowing the resins to be fusion-bonded to one another; this, however, leads to a poor convenience, and in view of extensive applications to various uses, it is at least required that a film be formed at a temperature near room temperature.

While polylactic acid is known as a typical biodegradable resin, it has a problem in film formability. As for film formation at a temperature near room temperature using a polylactic acid aqueous dispersion, there is known a method where a specific plasticizer is used in a combined manner to lower the glass-transition point of the polylactic acid so as to lower a minimum film-forming temperature (MFT); however, this method has a flaw that the properties inherent to resins will be impaired, such as a case where the film obtained by adding the plasticizer may exhibit an impaired water resistance.

Conventionally, as an aqueous dispersion employing a polycaprolactone in a biodegradable resin, there are proposed techniques that are disclosed in JP-A-2002-356612, JP-A-2004-018744, JP-A-2001-247392, JP-A-2001-011294, JP-A-2002-371259, JP-A-2005-047998, JP-A-2006-077186, JP-A-2005-103783 and JP-A-2003-073233.

### SUMMARY OF THE INVENTION

However, in the cases of these conventional techniques, they do not focus on forming a film with a high transparency, particularly on forming a transparent film at a temperature near room temperature, and no considerations are given, from such perspective, to the molecular weight of a polycaprolactone, the type of a dispersant and ratios. For example, although an aqueous dispersion using both a polylactic acid and a polycaprolactone is disclosed in, for example, JP-A-2002-356612 and JP-A-2004-018744, none of these documents provides satisfactory solutions to problems such as one that a transparent film cannot be obtained without a heating treatment after coating, and one that the transparency of the film obtained may deteriorate if the polycaprolactone has a relatively large molecular weight.

The present invention was made in view of the above circumstances, and it is an object of the present invention to provide a biodegradable resin aqueous dispersion from which a transparent film with an excellent biodegradability can be obtained without impairing the properties inherent to resins, and without performing a special heating treatment; a film forming agent using such dispersion; and a method for forming a film.

The inventors of the present invention diligently conducted a series of studies in order to solve the above problems, and completed the invention as below. That is, the inventors found that a transparent film could be obtained without performing a special heating treatment, by using, as a biodegradable resin, a polycaprolactone resin having a weight-average molecular weight of a particular range, and by employing a mass ratio of a non-ionic dispersant to the biodegradable resin(s) that belongs to a particular range.

Specifically, the biodegradable resin aqueous dispersion of the present invention is an aqueous dispersion with a biodegradable resin being dispersed in an aqueous solvent under the presence of a non-ionic dispersant, comprising, as the biodegradable resin, a polycaprolactone having a weight-average molecular weight of 20,000 to 90,000, wherein a mass ratio of the non-ionic dispersant to the biodegradable resin is 0.03 to 0.23.

The film forming agent of the present invention is the aforementioned biodegradable resin aqueous dispersion.

The method of the present invention for forming a film, includes:
a step of applying a composition containing the aforementioned biodegradable resin aqueous dispersion to a surface of a target object; and
a step of drying the composition to form a film on the surface of the target object.

According to the present invention, there can be obtained a transparent film with an excellent biodegradability without impairing the properties inherent to resins, and without performing a special heating treatment.

### BRIEF DESCRIPTION OF THE DRAWINGS

FIG. 1 includes a series of photographs in which a paper with black circular dots printed on it is placed under a glass slide on which a film has been formed after applying a biodegradable resin aqueous dispersion thereto and then drying the same, in the cases of working examples 11, 5 and 7 and comparative examples 3 and 2; and a photograph showing a cast film whose film formation was attempted by dissolving a biodegradable resin D in ethyl acetate and then drying the same.

### DETAILED DESCRIPTION OF THE INVENTION

Embodiments of the present invention are described hereunder.

### (Biodegradable Resin Aqueous Dispersion)

The biodegradable resin aqueous dispersion of the present invention is an aqueous dispersion with a biodegradable resin(s) being dispersed in an aqueous solvent under the presence of a non-ionic dispersant.

The biodegradable resin aqueous dispersion of the present invention contains, as a biodegradable resin, a polycaprolactone having a weight-average molecular weight of 20,000 to 90,000.

Polycaprolactone is a biodegradable polyester having a relatively low melting point and glass-transition temperature. A polycaprolactone may for example be produced, with the aid of a catalyst, by a ring-opening polymerization of ε-caprolactone as a cyclic ester and a lactone, and as a seven-membered ring compound represented by a chemical formula (CH₂)₅CO₂.

When the weight-average molecular weight of the polycaprolactone is not smaller than 20,000, there can be obtained a film with a practically sufficient strength. In this regard, it is preferred that the polycaprolactone have a weight-average molecular weight of not smaller than 22,000, more preferably not smaller than 25,000.

When the weight-average molecular weight is not larger than 90,000, there can be obtained a transparent film without performing a special heating treatment. In this regard, it is preferred that the polycaprolactone have a weight-average molecular weight of not larger than 88,000, more preferably not larger than 80,000.

The weight-average molecular weight (Mw) of the polycaprolactone may for example be obtained by a later-described method via gel permeation chromatography (GPC) where the molecular weight is compared with a known reference substance.

In the biodegradable resin aqueous dispersion of the present invention, a mass ratio of the non-ionic dispersant to the biodegradable resin(s) is 0.03 to 0.23.

When the mass ratio is not smaller than 0.03, there can be achieved a smaller particle size of the dispersed substance of the biodegradable resin aqueous dispersion whereby a favorable dispersed state can be maintained as a result of inhibiting agglomeration and sedimentation in the dispersion. Further, a transparent film can be obtained without performing a special heating treatment. In this regard, it is preferred that such mass ratio be not smaller than 0.04 in the case of the polycaprolactone.

When the mass ratio is not larger than 0.23, the non-ionic dispersant will only have a small impact on the properties of the polycaprolactone and the transparency of the film, and a transparent film can thus be obtained without performing a special heating treatment. In this regard, it is preferred that such mass ratio be not larger than 0.20 in the case of the polycaprolactone.

The biodegradable resin aqueous dispersion of the present invention may also contain, as a biodegradable resin, a resin other than the aforementioned polycaprolactone. There are no particular limitations on such biodegradable resin, examples of which may include a polylactic acid; a copolymer of lactic acid and other hydroxycarboxylic acid; and a dibasic polyester such as polybutylene succinate, polybutylene succinate adipate, polyethylene succinate, polyethylene terephthalate succinate, polybutylene adipate, and polybutylene adipate terephthalate. Any one kind of them may be used alone, or two or more kinds of them may be used in combination.

In a preferable embodiment, the biodegradable resin aqueous dispersion contains the polycaprolactone by an amount of not smaller than 50% by mass per a total amount of the biodegradable resin(s). In this way, a transparent film can be obtained without impairing the properties inherent to resins, and without performing a special heating treatment. From this perspective, the larger the amount of the polycaprolactone contained in the biodegradable resin aqueous dispersion with respect to the biodegradable resin(s) is, the more preferable it is; the biodegradable resin aqueous dispersion may contain, in an ascending order of preference, 60% by mass or more, 70% by mass or more, 80% by mass or more, 90% by mass or more, 95% by mass or more, or 98% by mass or more of the polycaprolactone per the total amount of the biodegradable resin(s). Most preferably, the polycaprolactone makes up all the biodegradable resin(s). Particularly, it is preferred that the biodegradable resin aqueous dispersion contain, for example, a polylactic acid as a biodegradable resin by an amount of smaller than 50% by mass per the total amount of the biodegradable resin(s); the smaller the amount of a polylactic acid contained with respect to the biodegradable resin(s), the more preferable it is. The biodegradable resin aqueous dispersion may contain, in an ascending order of preference, 40% by mass or less, 30% by mass or less, 20% by mass or less, 10% by mass or less, 5% by mass or less, or 2% by mass or less of a polylactic acid per the total amount of the biodegradable resin(s).

Alternatively, if containing, as a biodegradable resin, a resin other than the polycaprolactone, it is preferred that the biodegradable resin aqueous dispersion have a minimum film-forming temperature (MFT) of not higher than 30° C.; in an ascending order of preference, the minimum film-forming temperature (MFT) may be 28° C. or lower, 25° C. or lower, 23° C. or lower, or 20° C. or lower. In this way, a transparent film can be obtained without impairing the properties inherent to resins, and without performing a special heating treatment.

In the case of the biodegradable resin aqueous dispersion of the present invention, there are no particular limitations on the aqueous solvent, examples of which may include water, and a mixed solvent of water and an organic solvent that is compatible with water.

In the abovementioned mixed solvent, while there are no particular limitations on a ratio of water, it is preferred that the ratio of water be not smaller than 90% by mass, more preferably not smaller than 95% by mass, per a total amount of the mixed solvent.

In the abovementioned mixed solvent, there are no particular limitations on the organic solvent; the organic solvent may, for example, be a monovalent alcohol and a multivalent alcohol. Examples of the monovalent alcohol include methanol, ethanol, butanol, isopropyl alcohol (IPA), normal propyl alcohol and butanol; examples of the multivalent alcohol include glycerin and butylene glycol. Any one kind of them may be used alone, or two or more kinds of them may be used in combination.

In the case of the biodegradable resin aqueous dispersion of the present invention, there are no particular limitations on the non-ionic dispersant, examples of which may include a polyvinyl alcohol, a polyoxyalkylene condensate and a cellulose derivative. Any one kind of them may be used alone, or two or more kinds of them may be used in combination.

As the polyvinyl alcohol, preferred are those having a saponification degree of 70 to 95%, and a number average molecular weight of 50,000 to 300,000. When the saponification degree and number average molecular weight are within these ranges, a favorable dispersed state can be maintained as a result of inhibiting non-uniformity, agglomeration and sedimentation of the resin particles. The number average molecular weight (Mn) of the polyvinyl alcohol may for example be obtained by a later-descried method via gel permeation chromatography (GPC) where the molecular weight is compared with a known reference substance. Further, the saponification degree of the polyvinyl alcohol may be calculated from the hydroxyl value thereof.

As the polyoxyalkylene condensate, preferred is a copolymer of ethylene oxide and propylene oxide. A molar ratio between ethylene oxide (EO) and propylene oxide (PO) is preferably EO:PO=70:30 to 20:80, more preferably EO:PO=60:40 to 30:70.

Examples of the cellulose derivative include methylcellulose, carboxymethylcellulose, hydroxyethylcellulose, hydroxyethyl methylcellulose, and hydroxypropyl methylcellulose.

There are no particular limitations on the amount of the non-ionic dispersant contained; it is preferred that the non-ionic dispersant be contained in an amount of 3 to 23% by mass, more preferably 5 to 20% by mass, per the total amount of the biodegradable resin(s).

In the case of the biodegradable resin aqueous dispersion of the present invention, it is preferred that a solid content be not smaller than 30% by mass, more preferably not smaller than 35% by mass, per a total amount of the biodegradable resin aqueous dispersion. When the solid content is within these ranges, a drying efficiency will improve as the resin particles shall occupy a large portion of the aqueous dispersion. Further, when the viscosity of the aqueous dispersion is in an appropriate range, the resin particles can be stably dispersed without the aid of a viscosity adjustor such as a thickener. Here, it is preferred that the solid content be not larger than 50% by mass, more preferably not larger than 45% by mass. When the solid content is within these ranges, the viscosity of the aqueous dispersion will not become too high whereby a favorable handling property will be exhibited at the time of applying the aqueous dispersion. Particularly, the solid content refers to a ratio, in percentage terms, of a mass without a water content to the total amount of the biodegradable resin aqueous dispersion.

In a preferable embodiment, the biodegradable resin aqueous dispersion is such that the average particle size of the resin particles of the biodegradable resin(s) that are dispersed in the aqueous solvent is smaller than 4.0 μm. When the average particle size is within this range, the resins themselves will be present in a denser manner during a drying step, and the particles themselves will thus be easily fusion-bonded to one another, whereby a transparent film can be obtained without performing a special heating treatment. In this regard, the average particle size is preferably not larger than 2.0 μm.

Here, the average particle size of the resin particles is a value measured by a later-described method.

In a preferable embodiment, the biodegradable resin aqueous dispersion further contains an ionic dispersant having a weight-average molecular weight of not smaller than 300,000. By containing such ionic dispersant, the transparency of the film obtained can be improved without performing a special heating treatment. It is preferred that the weight-average molecular weight of the ionic dispersant be not smaller than 1,000,000, more preferably not smaller than 5,000,000.

The weight-average molecular weight (Mw) of the ionic dispersant may for example be obtained by a later-descried method via gel permeation chromatography (GPC) where the molecular weight is compared with a known reference substance.

As an ionic dispersant having a weight-average molecular weight of not smaller than 300,000, there may be listed, for example, an anionic compound, a cationic compound, or an amphoteric compound. Examples of such compound include a polymer and a surfactant. Any one kind of them may be used alone, or two or more kinds of them may be used in combination.

As an anionic dispersant having a weight-average molecular weight of not smaller than 300,000, there may be listed, for example, homopolymers of monomers such as an unsaturated monocarboxylic acid-based monomer, an unsaturated dicarboxylic acid-based monomer and an unsaturated sulfonic acid-based monomer; copolymers of these monomers themselves; and copolymers of these monomers such as an unsaturated monocarboxylic acid-based monomer, an unsaturated dicarboxylic acid-based monomer and an unsaturated sulfonic acid-based monomer with other monomers (simply referred to as another monomer(s) hereunder) that are copolymerizable with the aforesaid monomers. Examples of the unsaturated monocarboxylic acid-based monomer include acrylic acid, methacrylic acid, crotonic acid as well as neutralized and partially neutralized products of these acids. Examples of the unsaturated dicarboxylic acid-based monomer include maleic acid, fumaric acid, itaconic acid, citraconic acid as well as neutralized and partially neutralized products of these acids. Examples of the unsaturated sulfonic acid-based monomer include vinylsulfonic acid, allylsulfonic acid, methacrylsulfonic acid, styrenesulfonic acid, 2-acrylamido-2-methylpropanesulfonic acid, sulfoethyl(meth)acrylate, sulfoethylmaleimide, 3-allyloxy-2-hydroxypropanesulfonic acid as well as neutralized and partially neutralized products thereof.

As the anionic polymer compound, if using a copolymer of the monomer such as an unsaturated monocarboxylic acid-based monomer, an unsaturated dicarboxylic acid-based monomer and an unsaturated sulfonic acid-based monomer with another monomer, there are no particular limitations on such other monomer, examples of which may include an amide-based monomer such as (meth)acrylamide, isopropylamide and t-butyl(meth)acrylamide; a hydrophobic monomer such as (meth)acrylic acid alkyl ester, styrene, 2-methylstyrene and vinyl acetate; a hydroxyl group-containing monomer such as 2-hydroxyethyl(meth)acrylate, polyethylene glycol mono(meth)acrylate, polypropylene glycol mono(meth)acrylate, allyl alcohol, polyethylene glycol monoallyl ether, polypropylene glycol monoallyl ether, 3-methyl-3-butene-1-ol(isoprenol), polyethylene glycol monoisoprenol ether, polypropylene glycol monoisoprenol ether, 3-methyl-2-butene-1-ol(prenol), polyethylene glycol monoprenol ester, polypropylene glycol monoprenol ester, 2-methyl-3-butene-2-ol(isoprene alcohol), polyethylene glycol monoisoprene alcohol ether, polypropylene glycol monoisoprene alcohol ether, N-methylol(meth)acrylamide, glycerol monoallyl ether and vinyl alcohol; a phosphorus-containing monomer such as (meth)acrylamide methane phosphonic acid, (meth)acrylamide methane phosphonic acid methyl ester, and 2-(meth)acrylamide-2-methylpropane phosphonic acid; methoxy polyethylene glycol(meth)acrylate; and ethoxy propylene glycol(meth)acrylate.

The anionic polymer compound may be one prepared by further crosslinking, for example, the aforesaid homopolymer of the monomer such as an unsaturated monocarboxylic acid-based monomer, an unsaturated dicarboxylic acid-based monomer and an unsaturated sulfonic acid-based monomer, the aforesaid copolymer of these monomers themselves, or the aforesaid copolymer of any of these monomers with another monomer, with for example dibasic acids such as oxalic acid, malonic acid, succinic acid, glutaric acid, adipic acid, pimelic acid, suberic acid, azelaic acid and sebacic acid; alkyl esters of these dibasic acids; diisocyanates such as hexamethylene diisocyanate glycidyl ether and diphenylmethane diisocyanate; diepoxies such as ethylene glycol diglycidyl ether, polyethylene glycol diglycidyl ether and orthophthalic acid diglycidyl ether; polyglycidyl ethers such as sorbitan polyglycidyl ether and trimethylolpropane polyglycidyl ether; urea; guanidines; dibasic dihalide; or dialdehyde.

It is preferred that the anionic polymer compound be normally used as a salt of an appropriate basic compound; examples of such basic compound include hydroxides of alkali metals, hydroxides of alkali earth metals, amine compounds such as monoethanolamine and diisopropanolamine, and ammonia.

As the anionic polymer compound, those having a weight-average molecular weight of not smaller than 300,000 may be selected from the aforementioned compounds and used; specifically, of the above anionic polymer compounds, preferred is for example a polymer whose main component is comprised of at least one kind of an unsaturated monocarboxylic acid-based monomer or neutralized product thereof, and particularly preferred is a copolymer of an amide-based monomer with an unsaturated monocarboxylic acid-based monomer or neutralized product thereof e.g. a (meth)acrylamide/sodium(meth)acrylate copolymer is preferred.

As a cationic polymer dispersant having a weight-average molecular weight of not smaller than 300,000, there may be listed, for example, a cationic acrylic polymer and a cationic polyamine-based polymer.

Examples of the cationic acrylic polymer include homopolymers or copolymers of cationic acrylic monomers such as dimethylaminoethyl methacrylate, diethylaminoethyl methacrylate, dimethylaminopropyl methacrylate, dimethylaminoethyl acrylate, diethylaminoethyl acrylate, dimethylaminopropyl acrylate, dimethylaminomethyl methacrylamide, dimethylaminoethyl methacrylamide, dimethylaminopropyl methacrylamide, dimethylaminomethyl acrylamide, dimethylaminoethyl acrylamide, and dimethylaminopropyl acrylamide; and quaternary ammonium salts including methacrylic acid dimethylaminoethylmethyl chloride salt, methacrylic acid diethylaminoethyldimethyl sulfate and methacrylic acid dimethylaminopropyl chloroacetate and the like that are obtained by reacting the above cationic acrylic monomers with, for example, halogenated alkyl, dialkyl sulfate or monochloroacetic acid.

As the copolymer, there may be employed, for example, copolymers of the aforesaid cationic acrylic monomer and quaternary ammonium salt thereof with unsaturated bond-containing monomers that are copolymerizable with the aforesaid cationic acrylic monomer and quaternary ammonium salt thereof. Examples of such unsaturated bond-containing monomers include acrylic monomers such as alkyl acrylate, hydroxyalkyl acrylate, polyoxyethylene acrylate, alkoxy polyoxyethylene acrylate, alkyl methacrylate, hydroxyalkyl methacrylate, polyoxyethylene methacrylate, alkoxy polyoxyethylene methacrylate, acrylamide, methacrylamide, dimethylacrylamide, diethylacrylamide, isopropylacrylamide, dimethyl methacrylamide, diethyl methacrylamide, methylolacrylamide and morpholinyl acrylamide; vinyl ethers such as ethyl vinyl ether, hydroxybutyl vinyl ether, triethylene glycol vinyl ether and methoxytriethylene glycol vinyl ether; allyl ethers such as hydroxyethyl allyl ether, tetraethylene glycol allyl ether and methoxyethylene glycol allyl ether; carboxylic acid vinyl esters such as vinyl acetate, vinyl monochloroacetate and vinyl pivalate; vinyl amines such as vinylpyridine, vinylimidazole and methylvinylimidazole; and diallyl ammonium chloride.

Examples of the cationic polyamine-based polymer include polyamine-based polymers which are, for example, polymers of cyclic imines such as polyethyleneimine, polypropyleneimine, poly-3-methylpropylimine and poly-2-ethylpropylimine; polymers of unsaturated amines such as polyvinylamine and polyallylamine; and quaternary ammonium salts of these polymers. Further, there may also be used those obtained by adding an alkyl group, hydroxyalkyl group, acyl group, polyoxyalkylene group, carboxyalkyl group or the like to these polyamine-based polymers. The addition of an alkyl group, hydroxyalkyl group, acyl group, polyoxyalkylene group and carboxyalkyl group, can be respectively conducted by reacting alkyl halide, 1,2-epoxyalkane, acyl halide, ethylene oxide, and monochloroacetic acid or acrylic acid, with the polyamine-based polymer.

The cationic polymer compound may also be one prepared by further crosslinking the above cationic acrylic polymer and cationic polyamine-based polymer with, for example, dibasic acids such as oxalic acid, malonic acid, succinic acid, glutaric acid, adipic acid, pimelic acid, suberic acid, azelaic acid and sebacic acid; alkyl esters of these dibasic acids; diisocyanates such as hexamethylene diisocyanate glycidyl ether and diphenylmethane diisocyanate; diepoxies such as ethylene glycol diglycidyl ether, polyethylene glycol diglycidyl ether and orthophthalic acid diglycidyl ether; polyglycidyl ethers such as sorbitan polyglycidyl ether and trimethylolpropane polyglycidyl ether; urea; guanidines; dibasic dihalide; or dialdehyde.

In the present invention, if using, as the cationic polymer compound, a copolymer of a cationic acrylic monomer and another monomer, it is preferred that the cationic acrylic monomer be contained in the cationic polymer compound at a ratio of not smaller than 30 mol %. It is preferred that the cationic polymer compound be normally used as a salt of an appropriate acidic compound. Such acidic compound may be any of inorganic acids such as hydrochloric acid, sulfuric acid, formic acid and phosphoric acid, or any of organic acids such as acetic acid, oxalic acid, tartaric acid, malic acid, lactic acid and benzoic acid, of which acetic acid, phosphoric acid and lactic acid are preferred in terms of safety, price, heat stability, colorability or the like. As the cationic polymer compound of the present invention, a compound having a weight-average molecular weight of not smaller than 300,000 may be selected from the aforementioned compounds and used.

In the present invention, among the above listed cationic polymer compounds, particularly preferred is a polymer whose main component is an acrylamide-based copolymer.

There are no particular limitations on the contained amount of the ionic dispersant having a weight-average molecular weight of not smaller than 300,000; the contained amount thereof is preferably 0.005 to 1% by mass, more preferably 0.01 to 0.8% by mass, even more preferably 0.02 to 0.5% by mass, per the total amount of the biodegradable resin(s).

In a preferable embodiment, the biodegradable resin aqueous dispersion further contains at least one of a long-chain alkyltrimethyl quaternary ammonium salt and a polyoxyethylene dialkylsulfosuccinic acid salt. By containing these compounds, not only a transparent film can be obtained without performing a special heating treatment, but the water resistance of the film can be further improved as well.

The long-chain alkyl group in the long-chain alkyltrimethyl quaternary ammonium salt preferably has 12 to 22 carbon atoms. The long-chain alkyl group may be either linear or branched, and is preferably linear. There are no particular limitations on the long-chain alkyltrimethyl quaternary ammonium salt, examples of which may include a lauryltrimethyl ammonium salt, myristyltrimethyl ammonium salt, cetyltrimethyl ammonium salt, stearyltrimethyl ammonium salt and behenyltrimethyl ammonium salt. There are no particular limitations on a counter anion, examples of which may include a fluoride ion, chloride ion, bromide ion, iodide ion and sulfate ion, of which a chloride ion is preferred.

There are no particular limitations on the addition molar number of the oxyethylene in the polyoxyethylene dialkylsulfosuccinic acid salt; this addition molar number is preferably 1.0 to 10 mol, more preferably 2.0 to 5.0 mol. The alkyl group therein preferably has 8 to 22 carbon atoms. There are no particular limitations on the polyoxyethylene dialkylsulfosuccinic acid salt, examples of which may include a polyoxyethylene di-2-ethylhexyl sulfosuccinic acid salt, polyoxyethylene dilauryl sulfosuccinic acid salt, polyoxyethylene dimyristyl sulfosuccinic acid salt, polyoxyethylene dicetyl sulfosuccinic acid salt, and polyoxyethylene distearyl sulfosuccinic acid salt. Examples of a counter cation include, but are not particularly limited to a sodium ion, potassium ion and ammonium ion.

There are no particular limitations on the contained amount of at least one of the long-chain alkyltrimethyl quaternary ammonium salt and the polyoxyethylene dialkylsulfosuccinic acid salt; it is preferred that such contained amount be 0.005 to 1% by mass, more preferably 0.01 to 0.8% by mass, even more preferably 0.02 to 0.5% by mass, per the total amount of the biodegradable resin(s).

The biodegradable resin aqueous dispersion of the present invention may further contain other components other than those described above, on the premise that the effects of the present invention are not impaired.

Examples of such other components include, but are not particularly limited to an ionic dispersant having a weight-average molecular weight of smaller than 300,000, a viscosity adjustor, a surface smoothing agent, a water repellent agent (hydrophobicity improving agent), a mold release agent, an antirust agent, a fluidity adjustor, and waxes. Any one kind of them may be used alone, or two or more kinds of them may be used in combination.

While the biodegradable resin aqueous dispersion of the present invention may also contain a plasticizer, the smaller the amount thereof contained is, the more preferable it is; it is even more preferred that the biodegradable resin aqueous dispersion of the present invention does not contain a plasticizer. In order to form a film from a polylactic acid aqueous dispersion at a temperature near room temperature, there is known a method where a particular plasticizer is used in combination to lower the glass-transition point of the polylactic acid so as to lower the minimum film-forming temperature (MFT); a flaw with such method is that properties inherent to resins will be impaired depending on the additive amount and type of the plasticizer e.g. the film obtained by adding the plasticizer may exhibit an impaired water resistance. From this perspective, it is preferred that the biodegradable resin aqueous dispersion contain a plasticizer in an amount of not larger than 30% by mass, more preferably not larger than 25% by mass, even more preferably not larger than 20% by mass, per the total amount of the biodegradable resin(s); it is most preferred that the biodegradable resin aqueous dispersion does not contain a plasticizer.

As a plasticizer, a fatty acid ester-based plasticizer is preferred, examples of which include an adipic acid ester-based plasticizer, a citric acid ester-based plasticizer and a polyglyceryl fatty acid ester-based plasticizer.

There are no particular limitations on a method for producing the biodegradable resin aqueous dispersion of the present invention; the dispersion of the present invention may for example be produced by mixing and stirring a biodegradable resin(s), a dispersant such as a non-ionic dispersant, and an aqueous solvent.

Specifically, there may be employed, for example, a pressurizing dispersion method where a biodegradable resin(s), a dispersant such as a non-ionic dispersant, and as necessary, a viscosity adjustor and water are simultaneously put into a sealed tank equipped with a stirrer, followed by applying a pressure while performing heating and stirring so as to disperse the biodegradable resin(s); a direct dispersion method where a melted product containing a biodegradable resin(s), a dispersant such as a non-ionic dispersant, and as necessary, a viscosity adjustor is added to a hot water kept under a pressure, and is stirred so as to be dispersed therein; a phase inversion method where a biodegradable resin(s) are heated and melted, followed by adding thereto, while performing stirring, a water solution containing a dispersant such as a non-ionic dispersant and as necessary, a viscosity adjustor, thereby allowing the biodegradable resin(s) to be dispersed in the water; a method where an organic solvent, water, a biodegradable resin(s), a dispersant such as a non-ionic dispersant, and as necessary, a viscosity adjustor are added, stirred and dispersed, followed by eliminating the organic solvent; and a method where a water solution containing a dispersant such as a non-ionic dispersant and as necessary, a viscosity adjustor is added, while performing stirring, to an organic solvent solution of a biodegradable resin(s) so as to disperse the resin(s) therein, followed by eliminating the organic solvent.

In terms of applicability to a wider range of biodegradable resin types, and in consideration of the progress of hydrolysis, preferred is a method where an organic solvent, water, the aforesaid biodegradable resin(s), a dispersant such as a non-ionic dispersant and as necessary, a viscosity adjustor are put into a sealed tank equipped with a stirrer, followed by raising the temperature while stirring them so as to dissolve and disperse the solid raw materials, and then performing cooling, whereafter the organic solvent is to be eliminated under a reduced pressure.

Alternatively, also preferred is a method where an organic solvent and the biodegradable resin(s) are put into a sealed tank equipped with a stirrer, followed by raising the temperature while stirring them so as to dissolve the resin(s) and thus obtain a biodegradable resin-dissolved solution; meanwhile, water, a dispersant such as a non-ionic dispersant and as necessary, a viscosity adjustor are put into another stirring tank to prepare a water solution with these ingredients dissolved therein, followed by adding this water solution to the aforementioned sealed tank to disperse the resin(s) while performing stirring and raising the temperature to a temperature not lower than a resin dissolution temperature, whereafter cooling is conduced, and the organic solvent is then eliminated under a reduced pressure.

Although not particularly limited, examples of the organic solvent may include ester-based organic solvents which are, for example, formic acid esters such as methyl formate, ethyl formate, propyl formate and butyl formate, and acetic acid esters such as methyl acetate, ethyl acetate, propyl acetate and butyl acetate; chlorine-based organic solvents such as chloroform and carbon tetrachloride; and aromatic hydrocarbons such as benzene, toluene and xylene. Of these examples, preferred are the ester-based organic solvents with a favorable resin solubility; particularly preferred are the formic acid esters and acetic acid esters. In view of a sufficient dissolution of the resin(s) and a sufficient dissolution of the dispersant and viscosity adjustor, a mass ratio between the organic solvent and water is preferably organic solvent:water=1:9 to 9:1, more preferably 7:3 to 3:7.

As a dispersion stirring device for producing the biodegradable resin aqueous dispersion, a homomixer and a high-pressure emulsification machine may for example be used; however, without using such specialized device(s), there may for example be used a rotary stirring machine that is normally used to perform dispersion, mixing and stirring, and is equipped with a stirring blade such as a propeller blade, a paddle blade, a turbine blade, an anchor blade and/or a ribbon blade. Further, a stirring speed and a rotation speed may be those that are normally employed to perform dispersion and mixing. For example, there may be used a stirring blade where a ratio between a blade diameter (d1) of the stirring blade and an inner diameter (d2) of a stirring tank at the time of dispersion (blade ratio: d1/d2) is 0.5 to 0.85. Further, a peripheral speed of the stirring blade may be 1 to 8 m/s.

Since the biodegradable resin aqueous dispersion of the present invention can be provided in a simple, inexpensive and stable manner and is superior in film formation, it is suitable for use in cosmetic materials, coating material bases, covering agents, adhesive agents and the like.

### (Film Forming Agent and Method for Forming Film)

The biodegradable resin aqueous dispersion of the present invention can be used as a film forming agent.

A film formation method using the biodegradable resin aqueous dispersion of the present invention includes: a step of applying a composition containing the biodegradable resin aqueous dispersion to the surface of a target object; and a step of drying the composition to form a film on the surface of the target object.

In the case of the biodegradable resin aqueous dispersion of the present invention, the resin particles dispersed in the water will be fusion-bonded to one another to form a uniform film after the aqueous solvent has evaporated. Although not particularly limited, a temperature for forming the film is preferably not lower than 15° C., more preferably not lower than 25° C. Film formation easily takes place at a temperature near room temperature, and the resin particles will be fusion-bonded to one another to form a uniform film without performing a special heating treatment.

A film with a high transparency can be formed using the biodegradable resin aqueous dispersion of the present invention. As an index, with the glossiness of an uncoated glass slide being 100, a film formed at 20° C. after applying the biodegradable resin aqueous dispersion alone to the glass slide has a glossiness of not lower than 60, preferably not lower than 70, more preferably not lower than 85.

Although not particularly limited, the composition containing the biodegradable resin aqueous dispersion may for example be one fulfilling any of the aforementioned purposes such as a cosmetic product, a coating material, a covering agent and an adhesive agent.

There are no particular limitations on a method for applying the composition to the surface of the target object; there may be employed coating, spraying or the like according to the intended purposes. It is preferred that the composition be applied in such a manner that a uniform thin film will be formed. Devices such as a coating device and tools may be used as well.

When drying the composition to form the film on the surface of the target object, no particular limitations are imposed on a drying condition; drying may be performed under the abovementioned temperature condition, or in the form of natural drying in the air if dispersal of a solvent component such as water is allowed take place in a gradual manner.

The present invention has thus far been described based on the embodiments thereof; however, the invention shall not be limited to these embodiments, and may be variously modified without departing from the scope of the gist of the present invention.

### Working Examples

The present invention is descried in greater detail hereunder with reference to working examples; the invention shall not be limited to the following working examples.

### 1. Preparation of Biodegradable Resin Aqueous Dispersion

In the working and comparative examples, the materials shown below were used as the biodegradable resin(s), non-ionic dispersant, ionic dispersant and other components.

### (Biodegradable Resin)

A Polycaprolactone; weight-average molecular weight 10,000
B Polycaprolactone; weight-average molecular weight 25,000
C Polycaprolactone; weight-average molecular weight 37,000
D Polycaprolactone; weight-average molecular weight 50,000
E Polycaprolactone; weight-average molecular weight 80,000
F Polycaprolactone; weight-average molecular weight 120,000
G Polylactic acid; weight-average molecular weight 200,000

### (Non-Ionic Dispersant)

A Polyvinyl alcohol; number average molecular weight 100,000, saponification degree 80%
B Ethylene-modified polyvinyl alcohol; polymerization degree 1,700, saponification degree 93% (Exceval RS-1717 by Kuraray Co., Ltd.)
C Copolymer of ethylene oxide (EO) and propylene oxide (PO); number average molecular weight 3,300, EOPO ratio (EO:PO)=46:54

### (Ionic Dispersant)

A Polyacrylic acid/acrylic amide (mass ratio 80:20); weight-average molecular weight 18,000,000
B Cationic polyacrylic amide; weight-average molecular weight 8,000,000

### (Other Components)

A Stearyltrimethyl ammonium chloride
B Lauryltrimethyl ammonium chloride
C Polyoxyethylene (2) sodium dilauryl sulfosuccinate

At the compounding ratios shown in Table 1, the components were put into a sealed dispersion tank, followed by adding an ion-exchange water so that a total mass of the components therein would be 40% by mass in terms of solid content. Next, ethyl acetate of an amount 1.5 times larger than that of the ion-exchange water added was further added, followed by raising the temperature to 70° C. to disperse the components by a dispersion method using a given stirring dispersion device, before rapidly lowering the temperature to 40° C. A biodegradable resin aqueous dispersion was then obtained by eliminating the ethyl acetate under a reduced pressure.

### Average Molecular Weight

The average molecular weight i.e. weight-average molecular weight (Mw) and number average molecular weight (Mn) of the biodegradable resin(s) and dispersant refers to an average molecular weight in terms of polystyrene that is measured by gel permeation chromatography, using the following devices and conditions.

### [GPC Measurement Devices]

Column: by JASCO Corporation
Detector: RI detector for liquid chromatogram; RI-1530 by JASCO Corporation

### [Measurement Conditions]

Solvent: Chloroform (special grade)
Measurement temperature: 50° C.
Flow rate: 1.0 ml/min
Sample concentration: 15 mg/ml
Injection volume: 2 μl
Standard curve: Universal Calibration
Analysis program: ChromNAV (Ver. 1.19.02)

### Average Particle Size

The average particle size of the resin particles was measured by a laser diffraction-type particle size distribution measurement device (model SALD-2300 by SHIMADZU CORPORATION; refractive index 1.45-0.00 i).

### 2. Evaluation

The following evaluations were conducted on the biodegradable resin aqueous dispersions of the working and comparative examples.

The film was produced by the following procedure, using the biodegradable resin aqueous dispersion.

The biodegradable resin aqueous dispersion was applied to a glass slide of a size of 2.5 cm×7.5 cm, using a No. 4 bar coater, and was then dried at 20° C. for 24 hours to obtain a film.

### Film Transparency

The transparency of the film obtained was evaluated based on the criteria shown below. Using a handy glossmeter “GLOSS CHECKER IG-330” manufactured by HORIBA, Ltd., there was measured a glossiness of the glass slide surface on which the film had been formed. With the glossiness of the uncoated glass slide being 100, the evaluation was conducted according to the five levels listed hereunder.

### Evaluation Criteria

⊚+: Glossiness of not lower than 85
⊚: Glossiness of not lower than 70, but lower than 85
∘: Glossiness of not lower than 60, but lower than 70
Δ: Glossiness of not lower than 50, but lower than 60
x: Glossiness of lower than 50
   The evaluation results are shown in Tables 1 and 2.

### Film Water Resistance

The water resistance of the film obtained was evaluated based on the following criteria.

### Evaluation Criteria

A: The film did not whiten even after 10 sec had elapsed after delivering water thereonto by drops.
B: The film whitened within 10 sec after delivering water thereonto by drops.
   The evaluation results are shown in Table 2.

TABLE 1

| | | Working example | | | | | | | |
|---|---|---|---|---|---|---|---|---|---|
| Raw material | | 1 | 2 | 3 | 4 | 5 | 6 | 7 | 8 |
| Resin | Biodegradable resin A | | | | | | | | |
| | Biodegradable resin B | 100 | 60 | | | | | | |
| | Biodegradable resin C | | | 40 | | | | | |
| | Biodegradable resin D | | | | 100 | 100 | 100 | 100 | |
| | Biodegradable resin E | | | | | | | | 100 |
| | Biodegradable resin F | | | | | | | | |
| | Biodegradable resin G | | 40 | 60 | | | | | |
| Non-ionic | Non-ionic dispersant A | 5 | 15 | 10 | 3 | 5 | 20 | 23 | 5 |
| dispersant | Non-ionic dispersant B | | | | | | | | |
| | Non-ionic dispersant C | | | | | | | | |
| Ionic | Ionic dispersant A | | | | | | | | |
| dispersant | Ionic dispersant B | | | | | | | | |
| Solid content (%) | | 40 | 40 | 40 | 40 | 40 | 40 | 40 | 40 |
| Non-ionic dispersant/Resin | | 0.05 | 0.15 | 0.10 | 0.03 | 0.05 | 0.20 | 0.23 | 0.05 |
| Average particle size (μm) | | 2.2 | 1.1 | 3.2 | 4.3 | 2.0 | 0.9 | 0.9 | 2.0 |
| Evaluation | Transparency | ⊚ | ⊚ | ◯ | ◯ | ⊚ | ⊚ | ◯ | ⊚ |

| | | Working example | | | Comparative example | | | |
|---|---|---|---|---|---|---|---|---|
| Raw material | | 9 | 10 | 11 | 1 | 2 | 3 | 4 |
| Resin | Biodegradable resin A | | | | 100 | | | |
| | Biodegradable resin B | 100 | | | | | | |
| | Biodegradable resin C | | | | | | | |
| | Biodegradable resin D | | 100 | 100 | | | 100 | 100 |
| | Biodegradable resin E | | | | | | | |
| | Biodegradable resin F | | | | | 100 | | |
| | Biodegradable resin G | | | | | | | |
| Non-ionic | Non-ionic dispersant A | 5 | 5 | 3 | 5 | 5 | 2 | 25 |
| dispersant | Non-ionic dispersant B | | | 12 | | | | |
| | Non-ionic dispersant C | | | | | | | |
| Ionic | Ionic dispersant A | | 0.2 | 0.04 | | | | 0.04 |
| dispersant | Ionic dispersant B | 0.2 | | | | | | |
| Solid content (%) | | 40 | 40 | 40 | 40 | 40 | 40 | 40 |
| Non-ionic dispersant/Resin | | 0.05 | 0.05 | 0.15 | 0.05 | 0.05 | 0.02 | 0.25 |
| Average particle size (μm) | | 1.5 | 2.0 | 0.9 | 1.1 | 3.2 | 4.8 | 0.9 |
| Evaluation | Transparency | ⊚+ | ⊚+ | ⊚+ | X | X | Δ | Δ |

TABLE 2

| | | Working example | | | Reference example | | |
|---|---|---|---|---|---|---|---|
| Raw material | | 12 | 13 | 14 | 1 | 2 | 3 |
| Resin | Biodegradable resin A | | | | | | |
| | Biodegradable resin B | | | | | | |
| | Biodegradable resin C | 100 | | | 100 | | |
| | Biodegradable resin D | | | 100 | | | 100 |
| | Biodegradable resin E | | 100 | | | 100 | |
| | Biodegradable resin F | | | | | | |
| | Biodegradable resin G | | | | | | |
| Non-ionic | Non-ionic dispersant A | 9 | 5 | | 9 | 5 | |
| dispersant | Non-ionic dispersant B | | 5 | | | 5 | |
| | Non-ionic dispersant C | | | 10 | | | 10 |
| Ionic | Ionic dispersant A | 0.1 | | | 0.1 | | |
| dispersant | Ionic dispersant B | | 0.1 | | | 0.1 | |
| Other | Component A | 0.2 | | | | | |
| component | Component B | | 0.2 | | | | |
| | Component C | | | 0.2 | | | |
| Solid content (%) | | 40 | 40 | 40 | 40 | 40 | 40 |
| Non-ionic dispersant/Resin | | 0.09 | 0.10 | 0.10 | 0.09 | 0.10 | 0.10 |
| Average particle size (μm) | | 1.5 | 1.5 | 2.6 | 1.5 | 1.5 | 2.6 |
| Evaluation | Transparency | ⊚+ | ⊚+ | ⊚ | ⊚+ | ⊚+ | ⊚ |
| | Water resistance | A | A | A | B | B | B |

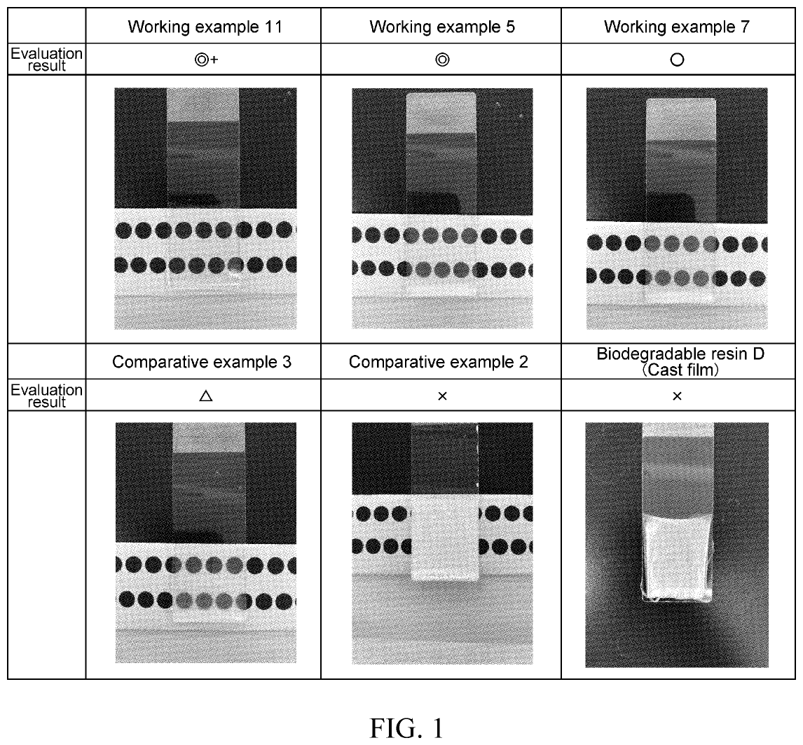

As is clear from Table 1, a transparent film was able to be obtained when the weight-average molecular weight of the resin was 20,000 to 90,000, as are the cases with the working examples 1, 5 and 6 and comparative examples 1 and 2. The glossiness i.e. the evaluation based on a value of an intensity ratio between an incident light and a regular reflection light is also correlated with a visually observed transparency degree shown in FIG. 1 as described later. In the comparative example 1, cracks were observed in the film as evaporation of water progressed; and it was also confirmed that when the weight-average molecular weight was smaller than 20,000, properties inherent to a polymer would be insignificant whereby the film obtained would exhibit a practically insufficient strength. The working example 4 and comparative example 3 indicate that a lower limit of the ratio of non-ionic dispersant/resin was 0.03 for obtaining a transparent film. A ratio lower than such lower limit would result in larger particle sizes of the resin, and thus an insufficient transparency of the film obtained. In the meantime, the working examples 6 and 7 and comparative example 4 indicate that the transparency of the film declined as the ratio of non-ionic dispersant/resin approached an upper limit of 0.23, and that the transparency was impaired due to a dullness in the film as the ratio exceeded 0.23. As shown by the working examples 2 and 3, it is understood that a transparent film can be obtained even when mixing a biodegradable resin other than polycaprolactone, and that the transparency can be improved by containing not smaller than 50% by mass, in terms of mass ratio, of polycaprolactone in all the biodegradable resins. Further, as shown by the working examples 9 to 11, it was confirmed that the transparency of the film had improved by containing an ionic polymer dispersant.

FIG. 1 is a series of photographs in which a paper with black circular dots printed on it is placed under the glass slide on which the film had been formed after applying the biodegradable resin aqueous dispersion thereto and then drying the same, where there are shown samples of the working examples 11, 5 and 7 and comparative examples 3 and 2 in a descending order of film transparency grading of ⊚+, ⊚, ∘, Δ and x. The more clearly the black circular dots can be seen, the higher the transparency is. As shown in FIG. 1, the clearness of the black circular dots increases following an ascending order of the grading in the glossiness evaluation, whereas whitishness was noticeable in the comparative examples 3 and 2. Attempts were made to form a film by dissolving the biodegradable resin D in ethyl acetate and then drying the same (cast film); the appearance of this film was white, and a uniform film was unable to be obtained.

As shown in Table 2, the working examples 12 to 14 indicate that the water resistance of the film can be improved by containing a particular compound (components A to C). Further, in this case, there shall be no hindrance even when using the ionic dispersants A and B in combination, where a film obtained thereby will exhibit a favorable water resistance while exhibiting an excellent transparency, which shall constitute a practically useful method.

What is claimed is:

1. A biodegradable resin aqueous dispersion which is an aqueous dispersion with a biodegradable resin being dispersed in an aqueous solvent under the presence of a non-ionic dispersant, comprising, as the biodegradable resin, a polycaprolactone having a weight-average molecular weight of 20,000 to 90,000, wherein a mass ratio of the non-ionic dispersant to the biodegradable resin is 0.03 to 0.23.

2. The biodegradable resin aqueous dispersion according to claim 1, wherein the polycaprolactone is contained in an amount of not smaller than 50% by mass per a total amount of the biodegradable resin.

3. The biodegradable resin aqueous dispersion according to claim 1, wherein an average particle size of resin particles of the biodegradable resin that are dispersed in the aqueous solvent is smaller than 4.0 μm.

4. The biodegradable resin aqueous dispersion according to claim 1, further comprising an ionic dispersant having a weight-average molecular weight of not smaller than 300,000.

5. The biodegradable resin aqueous dispersion according to claim 1, further comprising at least one of an alkyltrimethyl quaternary ammonium salt and a polyoxyethylene dialkylsulfosuccinic acid salt.

6. A film forming agent which is the biodegradable resin aqueous dispersion according to claim 1.

7. A method for forming a film, comprising:
a step of applying a composition containing the biodegradable resin aqueous dispersion according to claim 1 to a surface of a target object; and
a step of drying the composition to form a film on the surface of the target object.
